(19) United States
(12) Patent Application Publication
(10) Pub. No.: US 2020/0404951 A1
(43) Pub. Date: Dec. 31, 2020

(54) THIXOTROPIC ANTIMICROBIAL COMPOSITION

(71) Applicant: SAFE FOODS CORPORATION, North Little Rock, AR (US)

(72) Inventors: David MARSH, Fayetteville, AR (US); Lindsey PERRY, Hensley, AR (US); Orlando PAGAN, Coral Springs, FL (US); Slaton FRY, Conway, AR (US); Todd COLEMAN, Batesville, AR (US)

(21) Appl. No.: 16/968,037

(22) PCT Filed: Feb. 15, 2019
(86) PCT No.: PCT/US2019/018337

§ 371 Date: Aug. 6, 2020

Related U.S. Application Data
(60) Provisional application No. 62/710,422, filed on Feb. 16, 2018.

(51) Int. Cl. A23L 3/3499

(52) U.S. Cl. CPC A23L 3/3499

(57) ABSTRACT

A thixotropic antimicrobial composition includes a thixotropic agent and an antimicrobial agent. The thixotropic antimicrobial composition may be used to treat various food products or surfaces. Some thixotropic antimicrobial compositions may include peroxyacetic acid as an antimicrobial agent and/or xanthan gum or guar gum as a thixotropic agent. A treated article may include the thixotropic antimicrobial composition on at least one surface thereof.

### I. CROSS-REFERENCE TO RELATED APPLICATIONS

The present application claims benefit of U.S. Provisional Patent Application No. 62/710,422 filed Feb. 16, 2018, titled “Thixotropic Agents used to Increase Contact Time of Antimicrobial Agents on Treated Food Products,” which is incorporated herein by reference in its entirety.

### II. TECHNICAL FIELD

The present description relates to antimicrobial compositions including a thixotropic agent and an antimicrobial agent.

### III. BACKGROUND

Antimicrobial agents are commonly used to reduce bacterial contamination of food products such as poultry, beef, pork, fruits and vegetables. The efficacy of any antimicrobial agent is a function of many variables, but one key issue is the contact time of the antimicrobial agent on the surface of the treated food item. Most antimicrobial agents are applied as water solutions and have a very low viscosity and little to no thixotropic properties. This lack of viscosity and thixotropy causes the antimicrobial agent to drip off the surface of the treated food, greatly reducing the amount of available active ingredient.

### IV. SUMMARY OF THE DISCLOSURE

Exemplary embodiments of the present disclosure involve the use of thixotropic agents to add thixotropy and viscosity to compositions containing antimicrobial agents, thus allowing these solutions to have longer contact time on the surface of the treated food product. The present disclosure is also directed to a method of treating a food product, workpiece, or surface with thixotropic antimicrobial compositions including a thixotropic agent and an antimicrobial agent, and the treated food product, workpiece, or surface.

### V. DETAILED DESCRIPTION

Embodiments of the present disclosure involve thixotropic antimicrobial compositions comprising a thixotropic agent and an antimicrobial agent. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In embodiments of the present disclosure, the antimicrobial agent is not particularly limited, and may include any antimicrobial agent known in the art. Specific examples of suitable antimicrobial agents include, but are not limited to, cetylpyridinium chloride, peroxyacetic acid (PAA), citric acid, and lactic acid. Peroxyacetic acid may be advantageously employed, particularly in the poultry industry, due in part to microbial effectiveness and low cost. A combination of two or more antimicrobial agents may also be employed. For instance, the antimicrobial agent may include any of the following: mixtures of organic acids, such as a mixture of citric acid and lactic acid; mixtures of organic acids with generally regarded as safe (GRAS) acids, such as a mixture of citric acid and hydrochloric acid; or mixtures of GRAS acids and chlorine-based oxidizers, such as a mixture of citric acid and sodium chlorite (also known as acidified sodium chlorite or ASC).

In general, thixotropic agents may be employed to add thixotropy and viscosity to compositions. The thixotropic agent used in the thixotropic antimicrobial composition is not particularly limited and may constitute a blend of two or more thixotropic agents. Suitable thixotropic agents include, but are not limited to, guar gum, xanthan gum, pectin, arrowroot, cornstarch, potato starch, sago, tapioca, collagen, gelatin, agar, sodium pyrophosphate, polyacrylate salts, epoxy resins, other polymers that display thixotropic properties, and any mixture thereof. Of these, corn starch, guar gum, and xanthan gum may be advantageously employed, especially xanthan gum or a mixture of guar gum and xanthan gum.

In various embodiments, a thixotropic antimicrobial composition may be prepared by mixing a thixotropic solution containing a thixotropic agent dissolved therein with an antimicrobial solution containing an antimicrobial agent dissolved therein. The respective amounts of the thixotropic solution and the antimicrobial solution in the antimicrobial composition are not particularly limited. In some embodiments, a minimum ratio of thixotropic solution to antimicrobial solution in the thixotropic antimicrobial composition may be at least 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, or 2:1. In some embodiments, a maximum ratio of thixotropic solution to antimicrobial solution in the thixotropic antimicrobial composition may be 10:1, 7.5:1, 5:1, 4.5:1, 4:1, 3.5:1, 3:1, 2.5:1, 2:1, 1.9:1, 1.8:1, 1.7:1, 1.6:1, 1.5:1, 1.4:1, 1.3:1, 1.2:1, 1.1:1, or 1:1. The thixotropic solution and antimicrobial solution may be present in any range of ratios defined by any logical combination of the foregoing minimum and maximum ratios, for instance, the ratio may be 0.1:1 to 10:1, 0.1:1 to 5:1, 0.5:1 to 10:1, 0.5:1 to 5:1, 0.5:1 to 2.5:1, 0.5:1 to 1.5:1, or 0.7:1 to 1:1.

The concentration of the thixotropic agent in the thixotropic solution is not particularly limited. In various embodiments, the thixotropic agent may constitute between 0.05 mass % and 10 mass %, inclusive, based on the total mass of the thixotropic solution. For instance, based on the total mass of the thixotropic solution, the thixotropic agent may constitute 0.1 mass % or more, 0.5 mass % or more, 0.75 mass % or more, 1 mass % or more, 1.5 mass % or more, 2 mass % or more, 2.5 mass % or more, 3 mass % or more, 4 mass % or more, or 5 mass % or more. Further, the thixotropic agent may constitute 9 mass % or less, 8 mass % or less, 7 mass % or less, 6 mass % or less, 5 mass % or less, 4 mass % or less, 3 mass % or less, 2.5 mass % or less, 2 mass % or less, 1.5 mass % or less, or 1 mass % or less. The thixotropic agent may be present in the thixotropic solution in any range defined by any logical combination of the foregoing upper and lower limits, for instance, 0.1 to 5 mass %, 0.1 to 2.0 mass %, 0.5 to 1.5 mass %, or 0.1 to 1.0 mass %.

The concentration of the thixotropic agent in the thixotropic antimicrobial composition is not particularly limited. In various embodiments, the thixotropic agent may constitute between 0.01 mass % and 10 mass %, inclusive, based on the total mass of the thixotropic antimicrobial composition. For instance, based on the total mass of the thixotropic antimicrobial composition, the thixotropic agent may constitute 0.05 mass % or more, 0.1 mass % or more, 0.15 mass % or more, 0.2 mass % or more, 0.25 mass % or more, 0.3 mass % or more, 0.35 mass % or more, 0.4 mass % or more, 0.5 mass % or more, 0.75 mass % or more, 1 mass % or more, 1.5 mass % or more, 2 mass % or more, 2.5 mass % or more, 3 mass % or more, 4 mass % or more, or 5 mass % or more. Further, the thixotropic agent may constitute 9 mass % or less, 8 mass % or less, 7 mass % or less, 6 mass % or less, 5 mass % or less, 4 mass % or less, 3 mass % or less, 2.5 mass % or less, 2 mass % or less, 1.5 mass % or less, 1 mass % or less, 0.75 mass % or less, or 0.5 mass % or less. The thixotropic agent may be present in the thixotropic antimicrobial composition in any range defined by any logical combination of the foregoing upper and lower limits, for instance, 0.1 to 5 mass %, 0.1 to 2.0 mass %, or 0.5 to 1.5 mass %.

The content of the antimicrobial agent is not particularly limited and may, for example, include any commercially practical amount. In various embodiments, the antimicrobial agent may constitute between 10 ppm and 10,000 ppm, inclusive, based on the total mass of the thixotropic antimicrobial composition. For instance, based on the total mass of the thixotropic antimicrobial composition, a minimum content of the antimicrobial agent may be 10 ppm, 20 ppm, 30 ppm, 40 ppm, 50 ppm, 75 ppm, 100 ppm, 125 ppm, 150 ppm, 200 ppm, 250 ppm, 300 ppm, 350 ppm, 400 ppm, 450 ppm, 500 ppm, 550, ppm, 600 ppm, 650 ppm, 700 ppm, 750 ppm, 800 ppm, 900 ppm, 1,000 ppm, 1,100 ppm, 1,200 ppm, 1,300 ppm, 1,400 ppm, 1,500 ppm, 1,600 ppm, 1,700 ppm, 1,800 ppm, 1,900 ppm, or 2,000 ppm.

Further, based on the total mass of the thixotropic antimicrobial composition, a maximum content of the antimicrobial agent may be 50,000 ppm, 45,000 ppm, 40,000 ppm, 35,000 ppm, 30,000 ppm, 25,000 ppm, 20,000 ppm, 15,000 ppm, 10,000 ppm, 7,500 ppm, 5,000 ppm, 4,000 ppm, 3,000 ppm, 2,500 ppm, 2,000 ppm, 1,500 ppm, 1,250 ppm, 1,100, ppm, 1,000 ppm, 950 ppm, 900 ppm, 850 ppm, 800 ppm, 750 ppm, 700 ppm, 650 ppm, 600 ppm, 550 ppm, 500 ppm, 450 ppm, 400 ppm, 350 ppm, 300 ppm, 250 ppm, 200 ppm, 150 ppm, 100 ppm, 75 ppm, 50 ppm, or 25 ppm. The antimicrobial agent may be present in the thixotropic antimicrobial composition in any range defined by any logical combination of the foregoing minimum and maximum contents, for instance, 20-100 ppm, 20-75 ppm, 50-100 ppm, 50-500 ppm, 50-750 ppm, 500-750 ppm, 500-1,000 ppm, 750-1,000 ppm, 500-2,000 ppm, or 500-1,500 ppm.

In various embodiments, the thixotropic agent and antimicrobial agent may be supplied in any suitable form and subsequently mixed to form a thixotropic antimicrobial composition. Any order of mixing the constituents of the thixotropic antimicrobial composition may be employed. In such embodiments, the content of the thixotropic agent and antimicrobial agent, based on the total weight of the thixotropic antimicrobial composition, may be as described above. In various embodiments, the thixotropic antimicrobial composition, or components thereof prior to mixing, may be heated or cooled.

The thixotropic antimicrobial composition may contain additives such as solvents, carriers, oxidizing agents, viscosity builders, antioxidants, flavoring agents, preservatives, buffers, surfactants, solubility-enhancing agents, pH adjusters, or any combination thereof. Suitable solvents may include, for example, water, alcohols, organic solvents, or a combination thereof. Oxidizing agents may include, for instance, hydrogen peroxide, acylperoxy acids, ozone, or chlorine-based oxidizers.

In some embodiments, the present disclosure relates to a method for processing a food product, the method comprising sanitizing a food product with regard to at least one microorganism. In some embodiments, sanitizing a food product with regard to at least one microorganism may comprise contacting the food product with the thixotropic antimicrobial composition described herein. In various embodiments, the microorganisms may comprise Gram-positive bacteria, Gram-negative bacteria, fungi, protozoa or a combination thereof. The Gram-negative bacteria may comprise Salmonella, Campylobacter, Arcobacter, Aeromonas, non-toxin-producing Escherichia, pathogenic toxin-producing Escherichia or a combination thereof. The Gram-positive bacteria may comprise Staphylococcus, Bacillus, Listeria, or a combination thereof. The fungi may comprise Aspergillus flavus, Penicillium chrysogenum, or a combination thereof. The protozoa may comprise Entomoeba histolytica.

In some embodiments, the present disclosure relates to a method of sanitizing a workpiece with regard to at least one microorganism, the method comprising contacting the workpiece with the thixotropic antimicrobial composition described herein. The microorganism may, for example, be as described above. The workpiece may, for example, include food packaging, items and surfaces related to food or food processing, or items and surfaces unrelated to food or food processing.

In the methods of sanitizing described herein, the mode of applying the thixotropic antimicrobial composition is not particularly limited. Methods of applications may include, but are not limited to, spraying, misting, fogging, immersing, pouring, dripping, and combinations thereof. In some embodiments, the method of sanitizing includes mixing the thixotropic solution and the antimicrobial solution within a short time before contacting the resultant thixotropic antimicrobial composition with the food product or workpiece (i.e., the target article), for example, within 24 hrs, within 12 hrs, within 6 hrs, within 3 hrs, within 2 hrs, or within 1 hr.

Some methods of sanitizing relate to sanitizing food products or equipment during harvest and processing of the food product. Throughout the harvest process, there are many opportunities for antimicrobial interventions, and determining what works most effectively at each step may differ from processor to processor. As such, the timing of applying the thixotropic antimicrobial composition to the target article is not particularly limited. In some embodiments, the thixotropic antimicrobial composition may be applied to a food product prior to an evisceration process so as to adhere to the food product throughout the evisceration process, as well as when coming into contact with equipment, viscera, and humans.

In embodiments wherein the target article is poultry, the thixotropic antimicrobial composition may be applied in the processing facility in several different locations to include, but not limited to, the following; during the pick operation to post-picking prior to evisceration, onto evisceration equipment during operation, online reprocessing (OLR) location, offline reprocessing (OFLR) location, or pre-chill location, post-chill, on carcass frames post debone, and on various poultry parts in numerous locations in the plant. In embodiments wherein the target article is beef or pork, the thixotropic antimicrobial composition may be applied in the processing facility in several different locations to include, but not limited to, the following; hide on carcass application, equipment used during the harvest process, knife dip station, beef carcass application, sub-primal application, lean trimming application, and ground beef applications. In embodiments wherein the target article is fruit or vegetables, the thixotropic antimicrobial composition may be applied in the processing facility in several different locations to include, but not limited to, the following; all loading/unloading, all treatment pre-and post-flume, and prior and post to all cut up and smash treatment.

Embodiments of the present disclosure also relate to a treated article comprising a target article having a thixotropic antimicrobial composition on at least one surface thereof.

In some embodiments, the thixotropic antimicrobial composition may be present on an entire surface of the target article. In some embodiments, the thixotropic antimicrobial composition may comprise at least 0.5 mass %, at least 1 mass %, at least 1.5 mass %, at least 2 mass %, at least 2.5 mass %, at least 3 mass %, at least 3.5 mass %, at least 4 mass %, at least 4.5 mass %, at least 5 mass %, at least 5.5 mass %, at least 6 mass %, at least 7.5 mass %, at least 10 mass %, at least 12.5 mass %, at least 15 mass %, at least 17.5 mass %, at least 18 mass %, at least 18.5 mass %, at least 19 mass %, at least 19.5 mass %, at least 20 mass %, at least 21 mass %, at least 22.5 mass %, or at least 25 mass %, based on a total mass of the target article and the thixotropic antimicrobial composition or based on a total mass of the treated article. In some embodiments, the thixotropic antimicrobial composition may comprise at most 50 mass %, at most 40 mass %, at most 30 mass %, at most 25 mass %, at most 20 mass %, at most 18 mass % , at most 16 mass %, at most 15 mass %, at most 12.5 mass %, at most 11 mass %, at most 10 mass %, at most 9 mass %, at most 8 mass %, at most 7 mass %, at most 6 mass %, at most 5 mass %, at most 4 mass %, or at most 3 mass %, based on a total mass of the target article and the thixotropic antimicrobial composition or based on a total mass of the treated article. The thixotropic antimicrobial composition may be present in the treated article in any range defined by any logical combination of the foregoing minimum and maximum contents, for instance, 0.5 mass % to 50 mass %, 1 mass % to 20 mass %, 3 mass % to 15 mass %, or 3 mass % to 10 mass %. The target article, may for example, include a food product or workpiece as described above and the composition of the thixotropic antimicrobial composition may be as described above.

Beneficially, according to embodiments of the disclosure, the thixotropic agent increases viscosity of the thixotropic antimicrobial composition thereby allowing the thixotropic antimicrobial composition to better adhere to the target article and for a longer period of time. As such, the antimicrobial agent within the thixotropic antimicrobial composition is able to act on the target article for an extended period of time thereby further reducing the number of microorganisms on the target article. Additionally, the increased viscosity of the thixotropic antimicrobial composition provides the added benefit of reducing odor in the work environment caused by components of the thixotropic antimicrobial composition, such as the antimicrobial agent. Because the thixotropic antimicrobial agent adheres to the target article for an extended period of time, the frequency with which an antimicrobial-agent-containing composition needs to be applied to the target article is reduced; this may lead to further reduction of odor in the work environment. Therefore, higher concentrations of antimicrobial agents may be included in the thixotropic antimicrobial composition leading to further reduction of the number of microorganisms on the target article without an increase in odor. Further, embodiments of the disclosure may improve worker safety by reducing odor and thereby reducing irritation to plant workers and federal inspection personnel.

Equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

### EXAMPLES

### Example 1

Boneless, skinless chicken breasts from a local grocery chain were allowed to sit out at room temperature overnight, to ensure sufficient microbial growth. The following day, the boneless, skinless chicken breasts were cut into cubes, each weighing approximately 1 gram. A total of fifty cubes were cut, weighed, and combined into five groups of ten.

### Control Group (1)

As a control group (1), ten cubes were individually, aseptically rinsed per FSIS Directive 10,250.1 in 9 mL of buffered peptone water, this group (1) representing what was microbiologically present on the protein before treatment application. The rinsate from this procedure was collected for testing, as described below.

### Preparation of Treatments for Groups (2)-(5)

Three thixotropic antimicrobial compositions (groups (3)-(5)) and Promoat™ (group (2)) were diluted as necessary to achieve commercial usage properties. As an example, to prepare the treatment for group (5), a solution was prepared by fully dissolving 0.50 g of a thixotropic agent, xanthan gum (XG) (available from Spectrum Chemical Mfg. Corp.), in 100 ml of deionized water. This solution was added to 40 ml of a peroxyacetic acid solution, which was prepared by diluting 0.833 g of Promoat™ (a concentrated PAA solution available from Safe Foods Corp.) in 250 ml of deionized water, and the resultant mixture was diluted up to a total volume of 200 ml to form an XG-sticky PAA preparation having a PAA content of about 200 ppm. The PAA content was confirmed to be about 200 ppm via titration of a sample of the prepared XG-sticky PAA.

Similar procedures were followed to prepare the treatments used in groups (2)-(4). Namely, for group (2), no thixotropic agent was employed and the PAA content was measured as 195 ppm. For group (3), the thixotropic agent was guar gum (GG) (laboratory grade powder available from Aqua solutions, Inc.) and the PAA content was measured as 110 ppm. For group (4), the thixotropic agent was cornstarch (CS) and the PAA content was measured as 165 ppm.

### Evaluation of Treatments

Following the preparation of the treatments, each group of ten cubes was weighed, collectively, and each individual cube was placed in the respective treatment for sixteen seconds, removed from the treatment solution and allowed a drip time of one minute.

Following the drip time, each group of ten cubes was weighed, collectively to determine weight gain. Each individual cube was then aseptically rinsed per FSIS Directive 10,250.1 in 9 mL of buffered peptone water. This rinsate was collected for testing.

As samples were collected they were stored on ice, and following the completion of the study, the samples were shipped overnight on ice in a cooler to Merieux NutriSciences in Stone Mountain, Ga. for analysis. The samples were analyzed for 3M Aerobic Plate Count (APC) Petrifilm™ (AOAC Official Method 990.12), and Enterobacteriaceae (EB) Petrifilm™ (AOAC Official Method 2003.01).

### Experimental Results

TABLE 1
Weight gain

| | | PAA | | | |
|---|---|---|---|---|---|
| | | content | Initial | End wt. | Weight |
| Group | Treatment | (ppm) | wt. (g) | (g) | gain (%) |
| (1) | None | 0 | — | — | — |
| (2) | Promoat ™ | 195 | 18 | 18 | 0 |
| (3) | GG/PAA | 110 | 20 | 22 | 10 |
| (4) | CS/PAA | 165 | 18 | 22 | 22 |
| (5) | XG/PAA | ~200 | 19 | 24 | 26 |

As seen in Table 1 above, each of the thixotropic antimicrobial compositions used to treat groups (3)-(5) provided an increased adherence as measured by weight gain when compared to Promoat™ (group (2)). This indicates that the thixotropic antimicrobial compositions are capable of improving food safety by adhering to a target article for an extended period of time.

TABLE 2
Microorganism reduction

| | | PAA | | | | |
|---|---|---|---|---|---|---|
| | | content | | Log₁₀APC | | Log₁₀EB |
| Group | Treatment | (ppm) | Log₁₀APC | reduction | Log₁₀EB | reduction |
| (1) | None | 0 | 5.5 | — | 3.4 | — |
| (2) | Promoat ™ | 195 | 5.5 | 0 | 2.3 | 1.1* |
| (3) | GG/PAA | 110 | 5.4 | 0.1 | 3.3 | 0.1 |
| (4) | CS/PAA | 165 | 5.3 | 0.2* | 2.5 | 0.9* |
| (5) | XG/PAA | ~200 | 5.2 | 0.3* | 2.4 | 1.1* |

*Value of statistical significance using a 95% confidence interval.

As shown in Table 2 above, all three thixotropic antimicrobial compositions did show reductions in Aerobic Plate Count (APC) and Enterobacteriaceae (EB) counts (shown as logio of colony forming unit (CFU) per ml). This is significant as the above results were from samples taken after only one minute of drip time per FSIS Directives. However, the potential time for the antimicrobial agent to act on the target article is typically longer than one minute. Animal parts may remain on shackle lines or conveyors for extended periods of time between processing operations. For instance, moving animal parts from evisceration to a chiller may take between one and five minutes, depending on volume and plant layout.

It is expected that the effects shown in Table 2 would be amplified as treatment time increased. Further, the results in Tables 1 and 2 show that when the increase in weight was 20% or more, a statistically significant reduction in APC and EB was achieved.

### Example 2

Poultry wings, previously purchased from a local retailer and frozen, were set out at least seventy-two hours prior to the testing date to ensure proper thawing. A total of sixty wings were separated into six groups of 10.

### Control Group (1)

As a control group (1), ten wings were individually, aseptically rinsed per FSIS Directive 10,250.1 in 120 mL of buffered peptone water, this group (1) representing what was microbiologically present on the protein before treatment application. The rinsate from this procedure was collected for testing, as described below.

### Preparation of Treatments for Groups (2)-(6)

As the treatment for group (2), Promoat™ was diluted as necessary to achieve commercial usage properties for use in a chiller. The content of PAA was measured to be 55 ppm. As the treatment for group (4), Promoat™ was diluted as necessary to achieve commercial usage properties for use in a dip tank. The content of PAA was measured to be 705 ppm. As the treatment for group (3), a composition for use in a chiller was prepared by fully dissolving 0.5 g of xanthan gum (XG) (available from Spectrum Chemical Mfg. Corp.) in 100 ml of deionized water and adding the resultant mixture to a dilute solution of Promoat™ in a ratio of 2:1. The content of PAA was measured to be 50 ppm. As the treatment for group (5), a composition for use in a dip tank was prepared by combining the XG solution used in the group (3) treatment with a dilute solution of Promoat™ in a ratio of 1:2. The content of PAA was measured to be 735 ppm. The treatment used for group (6) was the same as that for group (5) except that the ratio of XG solution to dilute Promoat™ was 2:1, and the content of PAA was measured to be 705 ppm.

### Evaluation of Treatments

Following the preparation of each treatment, each group of ten wings was weighed, collectively, and each group of ten wings was separately placed in the respective treatment for sixteen seconds, removed from the treatment solution and allowed a drip time of one minute. Following the drip time, each group of ten wings was weighed to determine weight gain. Each individual wing was then aseptically rinsed per FSIS Directive 10,250.1 in 120 mL of buffered peptone water. This rinsate was collected for testing.

As samples were collected they were stored on ice, and following the completion of the study, the samples were shipped overnight on ice in a cooler to Merieux NutriSciences in Stone Mountain, Ga. for analysis. The samples were analyzed for 3M Aerobic Plate Count (APC) Petrifilm™ (AOAC Official Method 990.12), and Enterobacteriaceae (EB) Petrifilm™ (AOAC Official Method 2003.01).

### Experimental Results

TABLE 3
Weight gain

| | | PAA | | | |
|---|---|---|---|---|---|
| | | content | Initial | End | Weight |
| Group | Treatment | (ppm) | wt. (g) | wt. (g) | gain (%) |
| (1) | None | 0 | — | — | — |
| (2) | Promoat ™ | 50 | 668 | 668 | 0 |
| | chiller | | | | |
| (3) | XG/PAA 2:1 | 50 | 696 | 730 | 4.9 |
| | chiller | | | | |
| (4) | Promoat ™ dip | 705 | 606 | 620 | 2.3 |
| | tank | | | | |
| (5) | XG/PAA 1:2 | 735 | 676 | 704 | 4.1 |
| | dip tank | | | | |
| (6) | XG/PAA 2:1 | 705 | 733 | 778 | 6.1 |
| | dip tank | | | | |

As seen in Table 3 above, each of the thixotropic antimicrobial compositions used to treat groups (3), (5), and (6) provided an increased adherence as measured by weight gain when compared to Promoat™ (groups (2) and (4)). This indicates that the thixotropic antimicrobial compositions are capable of improving food safety by adhering to a target article for an extended period of time.

TABLE 4
APC Count Log10

| | | PAA | | | | | | | | | | | |
|---|---|---|---|---|---|---|---|---|---|---|---|---|---|
| | | content | Log₁₀CFU/ml | | | | | | | | | | |
| Group | Treatment | (ppm) | 1 | 2 | 3 | 4 | 5 | 6 | 7 | 8 | 9 | 10 | Avg. |
| (1) | None | 0 | 6.4 | 6.4 | 6.4 | 6.4 | 6.4 | 6.0 | 6.4 | 6.4 | 6.4 | 5.6 | 6.3 |
| (2) | Promoat ™ | 50 | 6.4 | 6.4 | 6.4 | 6.4 | 6.4 | 6.4 | 6.4 | 6.4 | 6.4 | 6.4 | 6.4 |
| | chiller | | | | | | | | | | | | |
| (3) | XG/PAA 2:1 | 50 | 6.4 | 6.4 | 6.4 | 6.4 | 6.4 | 6.4 | 6.4 | 6.4 | 6.4 | 6.4 | 6.4 |
| | chiller | | | | | | | | | | | | |
| (4) | Promoat ™ | 705 | 6.4 | 4.6 | 6.4 | 4.9 | 5.4 | 6.4 | 5.6 | 6.4 | 6.4 | 6.4 | 5.9 |
| | dip tank | | | | | | | | | | | | |
| (5) | XG/PAA 1:2 | 735 | 6.4 | 6.4 | 6.4 | 6.4 | 6.4 | 5.3 | 6.4 | 6.4 | 6.4 | 6.1 | 6.3 |
| | dip tank | | | | | | | | | | | | |
| (6) | XG/PAA 2:1 | 705 | 6.4 | 6.4 | 5.4 | 5.9 | 6.4 | 6.4 | 4.9 | 6.4 | 6.4 | 6.0 | 6.1 |
| | dip tank | | | | | | | | | | | | |

TABLE 5
EB Count CFU Log10

| | | PAA | | | | | | | | | | | |
|---|---|---|---|---|---|---|---|---|---|---|---|---|---|
| | | content | Log₁₀CFU/ml | | | | | | | | | | |
| Group | Treatment | (ppm) | 1 | 2 | 3 | 4 | 5 | 6 | 7 | 8 | 9 | 10 | Avg. |
| (1) | None | 0 | 3.3 | 3.0 | 4.0 | 2.9 | 4.4 | 3.7 | 3.1 | 4.7 | 3.2 | 3.4 | 3.6 |
| (2) | Promoat ™ | 50 | 4.5 | 4.4 | 2.6 | 3.7 | 2.5 | 2.1 | 5.7 | 3.5 | 2.7 | 3.3 | 3.5 |
| | chiller | | | | | | | | | | | | |
| (3) | XG/PAA 2:1 | 50 | 2.6 | 2.6 | 1.4 | 2.7 | 2.9 | 3.3 | 2.7 | 1.6 | 3.6 | 2.5 | 2.6 |
| | chiller | | | | | | | | | | | | |
| (4) | Promoat ™ | 705 | 3.5 | 1.8 | 3.0 | 0.8 | 2.0 | 3.4 | 1.2 | 2.8 | 3.5 | 0.5 | 2.2 |
| | dip tank | | | | | | | | | | | | |
| (5) | XG/PAA 1:2 | 735 | 1.7 | 2.7 | 1.8 | 1.9 | 1.3 | 1.1 | 2.2 | 2.5 | 6.0 | 1.2 | 2.2 |
| | dip tank | | | | | | | | | | | | |
| (6) | XG/PAA 2:1 | 705 | 2.6 | 2.1 | 1.1 | 1.5 | 3.1 | 1.6 | 1.7 | 3.8 | 1.5 | 2.1 | 2.1 |
| | dip tank | | | | | | | | | | | | |

TABLE 6
Microorganism reduction

| | | PAA | | | | |
|---|---|---|---|---|---|---|
| | | content | | Log₁₀APC | | Log₁₀EB |
| Group | Treatment | (ppm) | Log₁₀ APC | reduction | Log₁₀EB | reduction |
| (1) | None | 0 | 6.3 | — | 3.6 | — |
| (2) | Promoat ™ | 50 | 6.4 | (0.1) | 3.5 | 0.1 |
| | chiller | | | | | |
| (3) | XG/PAA | 50 | 6.4 | (0.1) | 2.6 | 1.0 |
| | 2:1 chiller | | | | | |
| (4) | Promoat ™ | 705 | 5.9 | 0.4 | 2.2 | 1.4 |
| | dip tank | | | | | |
| (5) | XG/PAA | 735 | 6.3 | 0.1 | 2.2 | 1.4 |
| | 1:2 dip tank | | | | | |
| (6) | XG/PAA | 705 | 6.1 | 0.2 | 2.1 | 1.5 |
| | 2:1 dip tank | | | | | |

As shown in Table 6 above, the thixotropic antimicrobial compositions provided similar or superior results as compared with Promoat™ alone. This is significant because, as shown in Table 3 above, the thixotropic antimicrobial compositions provided increase weigh gain over the Promoat™ only treatments. This suggests that the thixotropic antimicrobial compositions would remain on the target article (e.g., chicken wing) for a longer period allowing the antimicrobial agent to more effectively reduce the microorganism count on the target article. That is, the antimicrobial agents have a greater chance of coming into contact and destroying microorganisms when the exposure time is increased.

An additional group (7) was prepared in the same manner as group (3) except that the ratio of XG solution to dilute Promoat™ was 1:2, and a new control group (8) was prepared. The measured weight gain for group (7) was 3.9% (588 g initial weight and 611 g final weight). Group (7) did not provide any decrease in EB count compared to control group (8), but provided LogioAPC reduction of 1.1 as compared with control group (8).

### Example 3

Eleven test solution were individually charged into a 100 ml plastic graduated cylinder to a total volume of 60 ml. The composition of each solution is shown in Table 7 below. Each graduated cylinder was then capped with a rubber septum, swirled and inverted for 30 seconds, and allowed to settle for 60 seconds while keeping the headspace sealed with the rubber septum.

Thereafter, the rubber septum was removed, and amount of acetic acid (AcOH) in the headspace of each graduated cylinder was measured using 5-80ppm Acetic Acid Drager

Tubes by depressing the Drager bellow pump the number of times shown in Table 7 below. The same measurement procedures were also twice performed directly on the headspace in a bottle of 2250 ppm PAA, as shown in Test Nos. 5 and 8 of Table 7 below. Additionally, the amount of PAA was measured using a SFC PAA Test kit (TK7500-Z available from AquaPhoenix Scientific).

TABLE 7

| | | Solution Composition | | | | | | | |
|---|---|---|---|---|---|---|---|---|---|
| | | | 14% | 150 ppm | DI | 2250 ppm | 0.5% | Results | |
| Test | Pump | AcOH | PAA | PAA | H₂O | PAA | XG | PAA | AcOH |
| No. | Strokes | (ml) | (ml) | (ml) | (ml) | (ml) | (ml) | (ppm) | (ppm) |
| 1 | 3 | 60 | | | | | | | >80 |
| 2 | 3 | | 60 | | | | | | >80 |
| 3 | 3 | | | 20 | 40 | | | 45 | ND |
| 4 | 3 | | | | 40 | 20 | | 855 | <5 |
| 5 | 3 | | | | | In | | 2250 | <5 |
| | | | | | | bottle | | | |
| 6 | 3 | | | | | 20 | 40 | 825 | ND |
| 7 | 3 | | | | | 40 | 20 | 1545 | ND |
| 8 | 10 | | | | | In | | 2250 | 18-20 |
| | | | | | | bottle | | | |
| 9 | 10 | | | | 40 | 20 | | 870 | 5-10 |
| 10 | 10 | | | | | 20 | 40 | 855 | 5 |
| 11 | 10 | | | | 20 | 20 | 20 | 675 | 5 |
| 12 | 10 | | ~4 | | 36 | | 20 | >9000* | >80 |
| 13 | 10 | | ~1 | | 19 | | 40 | >2000* | 18-20 |

*Value calculated rather than measured

In general, the PAA mixture has a pungent odor due at least in part to the presence of both peroxyacetic acid and acetic acid. As shown in Table 7 above, the inclusion of a thixotropic agent with the PAA resulted in a decrease of acetic acid being detected in the headspace of the graduated cylinder. For instance, Test Nos. 6 and 7 demonstrated a decreased amount of acetic acid odor as compared with Test No. 4. This result is especially surprising for Test No. 7, which included nearly double the amount of PAA as compared with Test No. 4. Similar results were found when increasing the number of pump strokes. That is, Test Nos. 10 and 11 provided decreased odor as compared with Test No. 9.

Although the differences in ppm of AcOH reported in Table 7 above do not appear to be large, the Experimenters reported a significant decrease in odor for the compositions including a thixotropic agent (i.e., xanthan gum). Moreover, the above effects would be greatly amplified in an industrial setting due to the vast volume of antimicrobial agents employed and possibly further due to application methods employed, such as spraying. As such, by using a thixotropic antimicrobial composition including both an antimicrobial agent and a thixotropic agent, the undesirable odors associated with the antimicrobial agent or other components of the thixotropic antimicrobial composition can be suppressed and/or higher concentrations of the odor-producing components can be employed without an increase in odor as compared with traditional compositions. The foregoing results evidence the potential to greatly improve worker and federal inspector safety by decreasing workplace odors and irritation therefrom.

The above specific example embodiments are not intended to limit the scope of the claims. The example embodiments may be modified by including, excluding, or combining one or more features or functions described in the disclosure. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

1. A thixotropic antimicrobial composition comprising:
an antimicrobial agent; and
a thixotropic agent.

2. The thixotropic antimicrobial composition of claim 1, wherein the antimicrobial agent is at least one selected from the group consisting of cetylpyridinium chloride, peroxyacetic acid, citric acid, hydrochloric acid, sodium chlorite, and lactic acid.

3. The thixotropic antimicrobial composition of claim 1, wherein the antimicrobial agent is peroxyacetic acid.

4. The thixotropic antimicrobial composition of claim 1, wherein the thixotropic agent is at least one selected from the group consisting of guar gum, xanthan gum, pectin, arrowroot, cornstarch, potato starch, sago, tapioca, collagen, gelatin, agar, a polyacrylate salt, an epoxy resin, and sodium pyrophosphate.

5. The thixotropic antimicrobial composition of claim 1, wherein the thixotropic agent is xanthan gum and/or guar gum.

6. The thixotropic antimicrobial composition of claim 1, wherein the thixotropic agent is present in an amount of 0.1 mass % to 1.5 mass % based on a total weight of the thixotropic antimicrobial composition.

7. The thixotropic antimicrobial composition of claim 5, wherein the thixotropic agent is present in an amount of 0.1 mass % to 1.5 mass % based on a total weight of the thixotropic antimicrobial composition.

8. The thixotropic antimicrobial composition of claim 7, wherein the antimicrobial agent is peroxyacetic acid.

9. A method of sanitizing an article, the method comprising:
preparing a thixotropic antimicrobial composition; and
contacting the article with the thixotropic antimicrobial composition;
wherein the thixotropic antimicrobial composition comprises:
an antimicrobial agent; and
a thixotropic agent.

10. The method according to claim 9, wherein the antimicrobial agent is at least one selected from the group consisting of cetylpyridinium chloride, peroxyacetic acid, citric acid, hydrochloric acid, sodium chlorite, and lactic acid.

11. The method according to claim 9, wherein the antimicrobial agent is peroxyacetic acid.

12. The method according to claim 9, wherein the thixotropic agent is at least one selected from the group consisting of guar gum, xanthan gum, pectin, arrowroot, cornstarch, potato starch, sago, tapioca, collagen, gelatin, agar, a polyacrylate salt, an epoxy resin, and sodium pyrophosphate.

13. The method according to claim 9, wherein the thixotropic agent is xanthan gum and/or guar gum.

14. The method according to claim 9, wherein the thixotropic agent is present in an amount of 0.1 mass % to 1.5 mass % based on a total weight of the thixotropic antimicrobial composition.

15. The method according to claim 9, wherein, in the preparing step, the thixotropic antimicrobial composition is prepared by mixing a thixotropic solution containing the thixotropic agent with an antimicrobial solution containing the antimicrobial agent; and
wherein the contacting step is conducted within 6 hours of the preparing step.

16. The method according to claim 15, wherein the thixotropic solution comprises 0.5 mass % to 1.5 mass % of the thixotropic agent based on a total weight of the thixotropic solution.

17. The method according to claim 15, wherein a ratio of the thixotropic solution to the antimicrobial solution in the thixotropic antimicrobial composition is from 0.5:1 to 2.5:1.

18. A treated article comprising an article having a thixotropic antimicrobial composition on at least one surface thereof,
wherein the thixotropic antimicrobial composition comprises:
an antimicrobial agent; and
a thixotropic agent.

19. The treated article of claim 18, wherein the antimicrobial agent is peroxyacetic acid and
wherein the thixotropic agent is xanthan gum and/or guar gum.

20. The treated article of claim 19, wherein the thixotropic antimicrobial composition comprises 3 mass % to 25 mass % based on the total mass of the treated article.
